(19) United States
(12) Patent Application Publication
(10) Pub. No.: US 2015/0344150 A1
(43) Pub. Date: Dec. 3, 2015

(54) DEVICE AND METHOD FOR CHECKING A LANDING GEAR SHOCK ABSORBER

(71) Applicant: AIRBUS OPERATIONS LIMITED, Bristol (GB)

(72) Inventor: Julian DUNCAN, Bristol (GB)

(21) Appl. No.: 14/728,537

(22) Filed: Jun. 2, 2015

(30) Foreign Application Priority Data
Jun. 3, 2014 (GB) 1409875.0

(51) Int. Cl. B64D 45/00; G01C 9/00; G01M 17/04; F16B 1/00; B64C 25/58

(52) U.S. Cl. CPC B64D 45/0005; F16B 1/00; B64C 25/58; G01M 17/04; G01C 9/005; F16B 2001/0035

(57) ABSTRACT

The present invention relates to a device for checking a landing gear shock absorber. The device comprises first and second inclinometers. The first inclinometer is configured to measure the inclination of one of a slide, lower torque link and upper torque link of said shock absorber. The second inclinometer is configured to measure the inclination of another one of said slide, lower torque link and upper torque link.

The present invention relates to a device for checking a landing gear shock absorber and to a method of checking a landing gear shock absorber.

### BACKGROUND

Conventional aircraft typically comprise a landing gear having a shock absorber, otherwise known to those skilled in the art as an oleo strut, to reduce the loads transmitted to the airframe during taxiing and landing of the aircraft. An example of an aircraft 1 comprising such a landing gear 1A is illustrated in the side view of FIG. 1. The landing gear 1A of the aircraft 1 is shown in the side view of FIG. 2. A perspective view of the shock absorber 2 of the landing gear 1A is illustrated in FIG. 3. Some parts of the landing gear 1A (for example, the axles for mounting the wheels, and the upper part of the landing gear for receiving the oleo strut) have been omitted from FIGS. 1-3 for the purpose of clarity.

The shock absorber 2 comprises a tubular slide 4 that is coupled to a piston head (not shown) that is slidably received within a cylinder 3. The cylinder 3 is provided with a collar mount 5. The shock absorber 2 further comprises a scissor or torque link 6 having lower and upper torque links 6A, 6B. The torque link 6 inhibits rotation of the slide 4 relative to the cylinder 3, as is well known to those skilled in the art.

The upper end of the upper torque link 6B is pivotally coupled to the collar mount 5 by a first pivotal connection 5A. The lower end of the upper torque link 6B is pivotally coupled to the upper end of the lower torque link 6A by a hinge 6C. The lower end of the lower torque link 6A is pivotally coupled to an axle mount 8 by a second pivotal connection 8A. The axle mount 8 is configured to receive a wheel-bearing axle that has a plurality of landing wheels 9 rotatably attached thereto. The axle mount 8 is attached to the slide 4 such that the axle mount 8 may be moved relative to the collar mount 5 by sliding of the slide 4, and thus the piston head, within the cylinder 3.

The lower and upper torque links 6A, 6B comprise respective lower and upper planar members 7A, 7B. The lower and upper planar members 7A, 7B each comprise a hole 7C, 7D to reduce the weight of the torque link 6.

The cylinder 3 contains hydraulic oil and nitrogen gas. During landing of the aircraft 1, the slide 4 moves to slide the piston head within the cylinder 3 to compress the nitrogen gas such that the shock absorber acts as a pneumatic spring to absorb the kinetic impact of the landing. In addition, the hydraulic oil is forced through an orifice that connects two chambers (not shown) in the cylinder 3 to provide hydraulic damping during landing and taxiing of the aircraft 1.

It is important that the quantities of the hydraulic oil and nitrogen gas in the cylinder 3 are maintained within certain limits. For example, if the quantity of the nitrogen gas in the cylinder 3 is too low, the shock absorber 2 is at risk of “bottoming out” during landing, which can result in damage to the landing gear 1A. If the quantity of the nitrogen gas in the cylinder 3 is too high, the ability of the shock absorber 2 to dampen peak loading may be reduced and there is also a risk of the cylinder 3 rupturing under the application of a large load to the shock absorber 2, for example, due to a hard landing. Therefore, the quantities of the hydraulic oil and nitrogen gas in the cylinder 3 must be regularly measured and replenished if necessary.

The quantity of hydraulic oil and nitrogen gas in the cylinder 3 can be calculated by first measuring the extension of the slide 4 out of the cylinder 3. The extension of the slide 4 is referred to as the shock absorber extension or “H-dimension” and is shown by arrow ‘H’ in FIG. 2. The quantity of the nitrogen gas and hydraulic oil in the cylinder 3 can then be calculated using the measurement of the shock absorber extension H and measurements of the temperature and pressure of the nitrogen gas and hydraulic oil in the cylinder 3.

It is known in the art to use a rule to measure the shock absorber extension H manually. However, manual measurement of the shock absorber extension H is time consuming, inaccurate, and prone to human error.

U.S. Pat. No. 6,293,141 and US 2006/0220917 each disclose using a rotary variable differential transformer (RVDT) to measure the shock absorber extension electronically. The RVDT is built into the hinge of the torque link of the shock absorber to measure relative displacement of the upper and lower torque links. This measurement allows for the shock absorber extension to be determined, providing that the lengths of the upper and lower torque links are known. However, the RVDT is built into the hinge and so is a permanent feature of the landing gear, increasing the weight, cost and complexity of the aircraft. Furthermore, since the RVDT comprises moving parts, it is prone to wear and failure.

The present invention seeks to overcome or substantially alleviate at least some of the problems associated with the methods of checking a shock absorber referred to above.

### SUMMARY OF INVENTION

According to the invention, there is provided a device for checking a landing gear shock absorber comprising a first inclinometer configured to measure the inclination of one of a slide, lower torque link and upper torque link of said shock absorber and a second inclinometer configured to measure the inclination of another one of said slide, lower torque link and upper torque link.

In one embodiment, the device comprises a processor that is configured to calculate the shock absorber extension based on the inclinations measured by the first and second inclinometers.

The device may comprise a first mount configured to mount the first inclinometer to said one of the slide, lower torque link and upper torque link.

In one embodiment, the first mount is configured to be mounted to one of the lower and upper torque links and comprises an attachment means that is configured to be received in said one of the lower and upper torque links. In one such embodiment, said one of the lower and upper torque links comprises a hole and wherein the attachment means is configured to be inserted into said hole such that the attachment means is urged against the periphery of said hole to retain the first mount in position on said one of the lower and upper torque links. The attachment means may comprise a resilient material that is compressed when the attachment means is received in said one of the lower and upper torque links.

In one embodiment, the first mount comprises a body portion and the attachment means comprises a first disc-shaped member located proximate the body portion. The attachment means may comprise a second disc-shaped member that is located on the opposite side of the first disc-shaped member to the body portion and has a diameter smaller than the diameter of the first disc-shaped member.

In one embodiment, the first mount comprises a substantially flat abutment surface that sits flush to a planar surface of said one of the lower and upper torque links when the first mount is mounted thereto.

The device may comprise a second mount configured to mount the second inclinometer to said other one of the slide, lower torque link and upper torque link.

In one embodiment, the second mount is configured to be mounted to said slide and comprises an attachment means configured to be received against said slide. The attachment means may comprise first and second arms. The first and second arms may be configured such that the attachment means comprises a substantially “V” shaped surface.

In one embodiment, the attachment means comprises at least one magnet. In an alternative embodiment, the attachment means comprises a ratchet strap.

In one embodiment, the inclination of the slide, lower torque link and upper torque link is the angle between the horizontal and the slide, lower torque link and upper torque link respectively.

According to another aspect of the invention, there is provided a method of checking a landing gear shock absorber, wherein the shock absorber comprises a slide and upper and lower torque links, and wherein the method comprises the steps of: using a first inclinometer to measure the inclination of one of said slide, lower torque link and upper torque link; using a second inclinometer to measure the inclination of another one of said slide, upper torque link and lower torque link; and, calculating the shock absorber extension based on the inclinations measured by the first and second inclinometers.

In one embodiment, the step of calculating the shock absorber extension is performed using a processor.

The step of using the first inclinometer to measure the inclination of said one of the slide, lower torque link and upper torque link may comprise mounting the first inclinometer thereto using a first mount. The step of using the second inclinometer to measure the inclination of said other one of the slide, lower torque link and upper torque link may comprise mounting the second inclinometer thereto using a second mount.

The first and/or second inclinometers may comprise digital inclinometers and/or MEMS inclinometers.

According to another aspect of the invention, there is provided a mount for mounting an inclinometer to one of a slide, lower torque link and upper torque link of an aircraft shock absorber.

According to another aspect of the invention, there is provided a landing gear shock absorber and a device according to the invention, wherein the device is configured to check the landing gear shock absorber.

### BRIEF DESCRIPTION OF THE DRAWINGS

FIG. 1 is a side view of an aircraft comprising a known landing gear;

FIG. 2 is a side view of the known aircraft landing gear of FIG. 1;

FIG. 3 is a perspective view of a portion of the shock absorber of the aircraft landing gear of FIGS. 1 and 2;

FIG. 4 is a perspective view of a torque link mount of a device for checking a landing gear shock absorber according to a first embodiment of the invention;

FIG. 5 is a perspective view of the torque link mount of FIG. 4, mounted to a first shock absorber arrangement;

FIG. 6 is a schematic side view of the device of FIG. 4, mounted to the first shock absorber arrangement;

FIG. 7 is a flow chart illustrating operation of a processor of the device of FIG. 4;

FIG. 8 is a schematic side view of the device of FIG. 4, mounted to a second shock absorber arrangement;

FIG. 9 is a schematic side view of the device of FIG. 4, mounted to a third shock absorber arrangement;

FIG. 10 is a schematic side view of the device of FIG. 4, mounted to a fourth shock absorber arrangement;

FIG. 11 is a perspective view of a slide mount of a device for checking a landing gear shock absorber according to a second embodiment of the invention;

FIG. 12 is a perspective view of the slide mount of FIG. 11, mounted to the first shock absorber arrangement;

FIG. 13 is a schematic side view of the device of FIG. 11, mounted to the first shock absorber arrangement;

FIG. 14 is a schematic view of the device of FIG. 11, mounted in an alternative configuration to the first shock absorber arrangement;

FIG. 15 is a schematic side view of the device of FIG. 11, mounted to the second shock absorber arrangement;

FIG. 16 is a schematic view of the device of FIG. 11, mounted in an alternative configuration to the second shock absorber arrangement;

FIG. 17 is a schematic side view of the device of FIG. 11, mounted to the third shock absorber arrangement;

FIG. 18 is a schematic view of the device of FIG. 11, mounted in an alternative configuration to the third shock absorber arrangement;

FIG. 19 is a schematic side view of the device of FIG. 11, mounted to the fourth shock absorber arrangement;

FIG. 20 is a schematic view of the device of FIG. 11, mounted in an alternative configuration to the fourth shock absorber arrangement;

FIG. 21 is a block diagram illustrating a configuration of the device according to the first and second embodiments of the invention.

### DESCRIPTION OF THE EMBODIMENTS

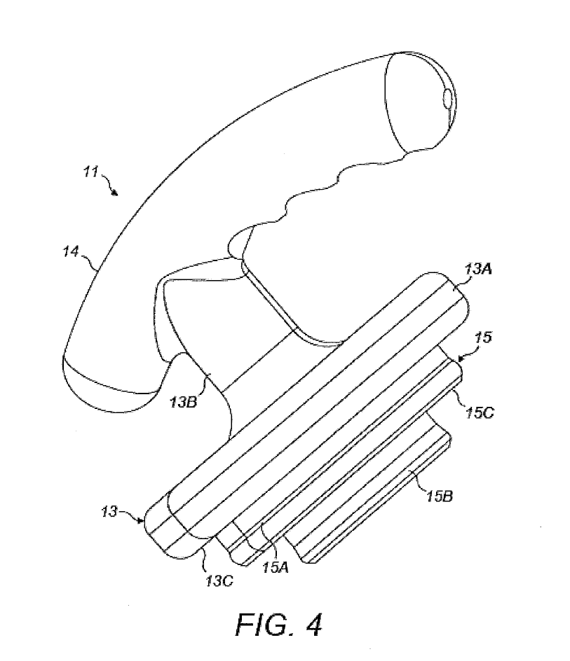

Embodiments of the invention will now be described, by way of example only, with reference to FIGS. 4 to 21 of the accompanying drawings.

Referring now to FIGS. 4 to 21, a device for checking a landing gear shock absorber according to a first embodiment of the invention is shown. The device comprises first and second torque link mounts 11, 12, first and second inclinometers (not shown), a processor (not shown) and a display (not shown). The first and second torque link mounts 11, 12 are identical in construction and therefore, for the sake of brevity, only the first torque link mount 11 will be described in detail hereinafter.

The first torque link mount 11 comprises a body portion 13 with a handle 14 disposed at one end thereof. The body portion 13 comprises a generally disc-shaped planar member 13A and a connecting portion 13B. The planar member 13A comprises opposing first and second major surfaces. The connecting member 13B extends perpendicularly from the first major surface of the planar member 13A. The handle 14 is located at the end of the connecting member 13B that is distal to the planar member 13A.

The first torque link mount 11 comprises an attachment means 15 that has disc-shaped first and second attachment elements 15A, 15B. The first attachment element 15A has a diameter that is smaller than the diameter of the disc-shaped planar member 13A of the body portion 13 and is larger than the diameter of the second attachment element 15B. The planar member 13A of the body portion 13 and the first and second attachment elements 15A, 15B are concentrically arranged such that the major surfaces thereof are parallel.

The first attachment element 15A is located at the second major surface of the planar member 13A such that the first attachment element 15A covers a portion of the second major surface. Since the first attachment element 15A has a diameter that is smaller than the diameter of the planar member 13A, the periphery of the second major surface of the planar member 13A is not covered by the first attachment element 15A. The portion of the second major surface that is not covered by the first attachment element 15A comprises a first abutment surface 13C

The second attachment element 15B is located on the other side of the first attachment element 15A to the body portion 13 such that the second attachment element 15B covers a portion of a major surface of the first attachment element 15A. Since the second attachment element 15B has a diameter that is smaller than the diameter of the first attachment element 15A, the periphery of said major surface of the first attachment element 15A is not covered by the second attachment element 15B. The portion of said major surface that is not covered by the second attachment element 15B comprises a second abutment surface 15C.

The planar member 13A, connecting member 13B, handle 14 and first and second attachment elements 15A, 15B of the first torque link mount 11 are integrally formed or are secured together, for example, by adhesive or screws.

The periphery of the first and second attachment elements 15A, 15B comprises a resilient material, for example, rubber or foam.

The first and second inclinometers comprise micro-electromechanical systems (MEMS) inclinometer sensors. In the present embodiment, the first and second inclinometers each comprise an ADIS16209 digital inclinometer manufactured by ANALOG DEVICES™. However, it should be recognised that the device of the present invention may comprise other types of inclinometers, including analogue and digital inclinometers and inclinometers other than MEMS inclinometers. In one alternative embodiment, the first and second inclinometers each comprise a T-Series analogue inclinometer manufactured by BEI SENSORS™.

The first and second inclinometers are disposed on or inside the connecting members 13B of the first and second torque link mounts 11, 12 respectively. The first and second inclinometers may be releasably mounted to the respective first and second torque link mounts 11, 12 by, for example, non-permanent adhesive, screws, a bracket or a clamp. Alternatively, the housing of the first and second inclinometers may be integrally formed with the first and second torque link mounts 11, 12 respectively. In alternate embodiments (not shown), the first and second inclinometers are disposed in or on the planar members 13A, handles 14 or attachment means 15 of the first and second torque link mounts 11, 12 respectively.

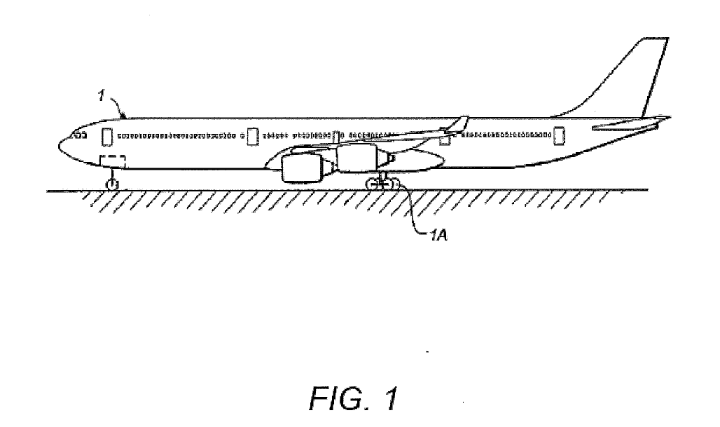

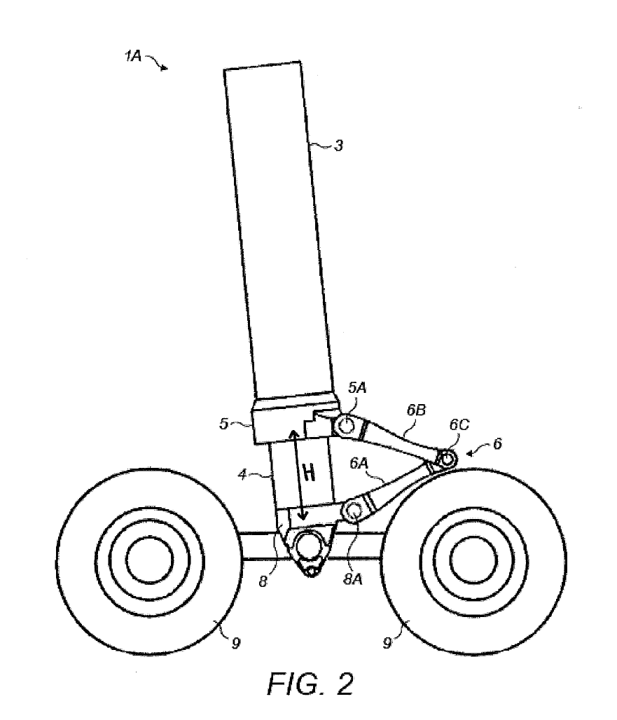

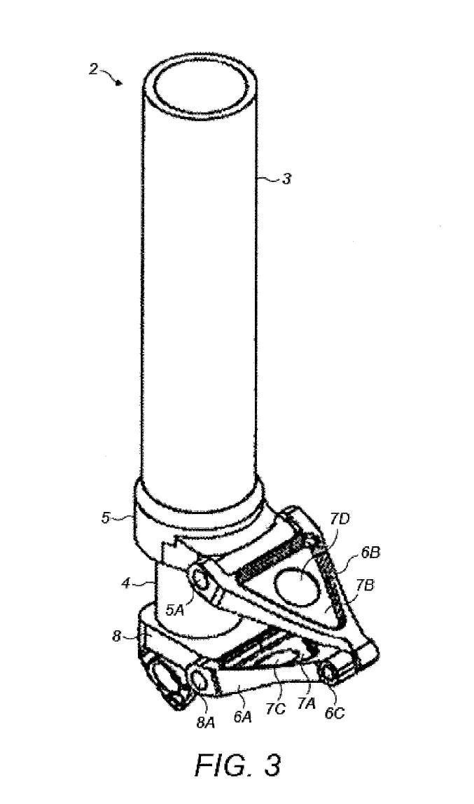

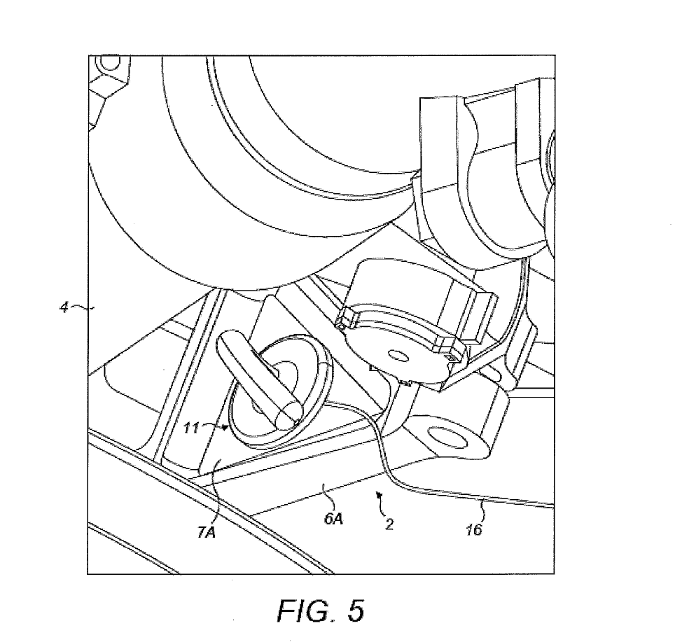

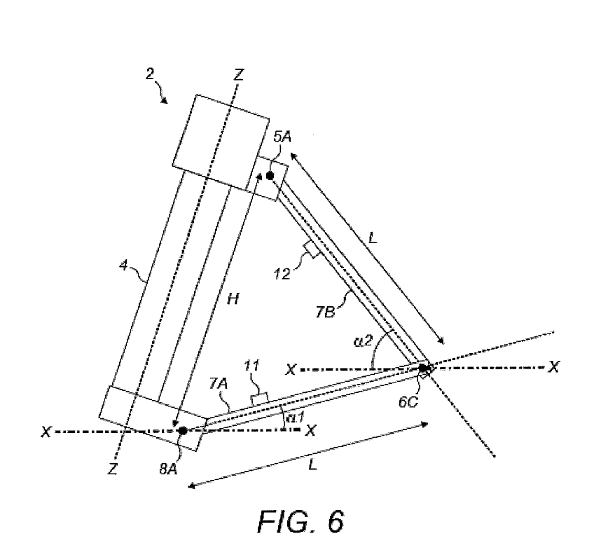

FIGS. 5 and 6 show the device of the first embodiment of the invention mounted to a shock absorber 2 that is identical in construction to the shock absorber 2 shown in FIGS. 1 to 3, with like components retaining the same reference numerals.

The first and second torque link mounts 11, 12 are configured to be removably mounted to the lower and upper torque links 6A, 6B respectively of the torque link 6 of the shock absorber 2 so that the first and second inclinometers measure the inclinations α1, α2 of the lower and upper planar members 7A, 7B respectively.

To mount the first torque link mount 11 to the lower torque link 6A, the user grips the handle 14 of the first torque link mount 11 and inserts the attachment means 15 into the hole 7C disposed in the lower planar member 7A. This will cause the resilient material at the periphery of one of the first and second attachment elements 15A, 15B to be urged against the periphery of the hole 7C such that resilient material is compressed and the first torque link mount 11 is held firmly in position on the lower torque link 6A. If the hole 7C has a diameter that is equal to or slightly smaller than the diameter of the second attachment element 15B, then when the first torque link mount 11 is mounted to the lower torque link 6A only the second attachment element 15B will protrude into the hole 7C. Therefore, the resilient material at the periphery of the second attachment element 15B will be urged against the lower torque link 6A at the periphery of the hole 7C and the second abutment surface 15C will sit flush to a major surface of the lower planar member 7A. Alternatively, if the hole 7C has a diameter that is equal to or slightly smaller than the diameter of the first attachment element 15A, but larger than the diameter of the second attachment element 15B, then when the first torque link mount 11 is mounted to the lower torque link 6A the first and second attachment elements 15A, 15B will protrude into the hole 7C. Therefore, the resilient material at the periphery of the first attachment element 15A will be urged against the lower torque portion 6A at the periphery of the hole 7C and the first abutment surface 13C will sit flush to a major surface of the lower planar member 7A. Thus, since the first torque link 11 comprises first and second attachment elements 15A, 15B having different diameters, the first torque link mount 11 is suitable for being mounted to torque links 6 with a variety of different hole diameters.

To mount the second torque link mount 12 to the upper torque link 6B, the user grips the handle of the second torque link mount 12 and inserts the attachment means into the hole 7D disposed in the upper planar member 7B of the torque link 6. This will cause the first or second attachment element, depending on the diameter of the hole 7D, to be urged against the portion of the upper torque link 6B at the periphery of the hole 7D such that the resilient material of the first or second attachment element is compressed to hold the second torque link 12 in position. When the second torque link mount 12 is mounted to the upper torque link 6B, one of the first or second abutment surfaces of the second torque link mount 12 will sit flush to a major surface of the upper planar member 7B, similarly to as described above in reference to the mounting of the first torque link mount 11. Since the second torque link 12 comprises first and second attachment elements having different diameters, the second torque link mount 12 is suitable for being mounted to torque links 6 with a variety of different hole diameters.

Since the first or second abutment surface 13C, 15C sits flush to a major surface of the lower planar member 7A when the first torque link mount 11 is mounted to the lower torque link 6A, consistent alignment of the first inclinometer with respect to the lower planar member 7A can be achieved, with the connecting member 13B of the body portion 13 extending perpendicularly to said major surface of the lower planar member 7A. Similarly, since the first or second abutment surface of the second torque link mount 12 sits flush to a major surface of the upper planar member 7B when the second torque link mount 12 is mounted to the upper torque link 6B, consistent alignment of the second inclinometer with respect to the upper planar member 7B can be achieved. Thus, repeatable, consistent and accurate measurement of the inclinations α1, α2 of the lower and upper planar members 7A, 7B is possible.

The attachment means 15 of the present invention having first and second attachment elements 15A, 15B of different diameters allows for the first and second torque link mounts 11, 12 to be mounted to planar members 7A, 7B having a range of hole diameters. However, it should be recognised that the invention is not limited to the attachment means 15 of the first and second torque link mounts 11, 12 having two attachment elements 15A, 15B. For example, in an alternative embodiment (not shown) the attachment means each further comprise a third attachment element that is located on the other side of the second attachment element to the first attachment element and has a diameter that is smaller than the second attachment element. In such an embodiment, a portion of a major surface of each of the second attachment elements would comprise a second abutment surface that is not covered by a corresponding third attachment element. In another embodiment (not shown), the second attachment elements are omitted such that each of the first and second torque link mounts comprises only one attachment element.

The first and second torque link mounts 11, 12 are easily dismounted from the respective lower and upper torque links 6A, 6B by pulling the handles 14 to remove the respective attachment means 15 from the corresponding holes 7C, 7D in the lower and upper planar members 7A, 7B. Therefore, the first and second torque link mounts 11, 12 can be mounted to, and dismounted from, a conventional shock absorber without requiring modification of the shock absorber.

Although in the above described embodiment the attachment means 15 of the first and second torque link mounts 11, 12 each comprise a resilient material, in an alternate embodiment (not shown) the resilient material and/or the first and second attachment elements 15A, 15B are omitted. In one such embodiment (not shown), the attachment means each comprises a bracket or brace that is configured to be inserted into a corresponding hole in the lower and upper torque links. The bracket or brace is then adjusted such that a portion of the bracket or brace is urged against the periphery of the corresponding hole to hold the torque link mounts in position. In another embodiment (not shown), each attachment means comprises an inflatable member that is attached to the body portion. The inflatable members are inserted into corresponding holes in the lower and upper torque links and are then inflated such that the inflatable members are urged against the periphery of the corresponding holes to hold the torque link mounts in position. In yet another embodiment (not shown), the first and second attachment elements are omitted and instead the planar members of the first and second torque link mounts are mounted to major surfaces of the lower and upper torque links respectively by screws, non-permanent adhesive or magnets.

Although in the above described embodiments the first and second attachment elements 15A, 15B are circular disc shaped to fit into the circular holes 7C, 7D located in the lower and upper planar members 7A, 7B of the shock absorber 2, it should be recognised that the first and second attachment elements 15A, 15B may have an alternative shape, for example, rectangular or hexagonal.

The first inclinometer is connected to the processor by a cable 16 such that the value of the inclination α1 of the lower planar member 7A is input into the processor. The inclination α1 of the lower planar member 7A is the angle of the lower planar member 7A with respect to the horizontal (shown by dashed line X-X). Similarly, the second inclinometer is connected to the processor by a cable (not shown) such that the value of the inclination α2 of the upper planar member 7B is input into the processor. The inclination α2 of the upper planar member 7B is the angle of the upper planar member 7B with respect to the horizontal X-X. It should be recognised that the first and/or second inclinometers may alternatively be coupled to the processor using wireless communications technology.

The distance between the first pivotal connection 5A and the central axis Z-Z of the slide 4 is equal to the distance between the second pivotal connection 8A and the central axis Z-Z of the slide 4. Therefore, the distance between the first and second pivotal connections 5A, 8A is equal to the shock absorber extension H.

The length L of the lower torque link 6A is the distance between the second pivotal connection 8A and the hinge 6C. The length L of the upper torque link 6B is the distance between the first pivotal connection 5A and the hinge 6C. The lengths L of the lower and upper torque links 6A, 6B are equal. The shock absorber extension H can be calculated from the value of the length L and the value of the inclinations α1, α2 of the lower and upper planar members 7A, 7B using trigonometry.

The length L of the lower and upper torque links 6A, 6B may be found by measurement using a rule or may be pre-programmed into the processor. The length L of the lower and upper torque links 6A, 6B are not affected by the quantities of the nitrogen gas and hydraulic oil in the shock absorber 2 and therefore only need to be measured once. Alternatively, the length L may be found in the servicing manual for the aircraft.

Equation 1 shows the relationship between the shock absorber extension H, the length L of the lower and upper torque links 6A, 6B, and the inclinations α1, α2 of the lower and upper planar members 7A, 7B.

$$H = 2 L sin ( \frac{\vert α 1 \vert + \vert α2 \vert}{2} ) \qquad [ Equation 1 ]$$

The processor is programmed with the length L of the lower and upper torque links 6A, 6B. The values of the inclinations α1, α2 of the lower and upper planar members 7A, 7B measured by the first and second inclinometers are input into the processor, which calculates the shock absorber extension H using Equation 1. The processor is coupled to the display such that the calculated shock absorber extension H is displayed to the user. The user can then use the calculated shock absorber extension H to calculate the volumes of nitrogen gas and hydraulic oil in the shock absorber 2, using methods known in the art.

In the above described embodiment the device is mounted to a configuration of shock absorber 2 wherein the shock absorber extension H is equal to the distance between the first and second pivotal connections 5A, 8A. However, it should be recognised that the device may alternatively be mounted to an alternative configuration of shock absorber (not shown) wherein the actual extension of the shock absorber is not equal to the distance between the first and second pivotal connections 5A, 8A and instead a fixed offset is applied to Equation 1 to calculate the actual shock absorber extension. For example, the actual shock absorber extension that is used to calculate the quantity of gas in the shock absorber may be a set distance greater than the shock absorber extension H calculated using Equation 1 and so said set distance would be added to the shock absorber extension H calculated using Equation 1 to give the actual shock absorber extension.

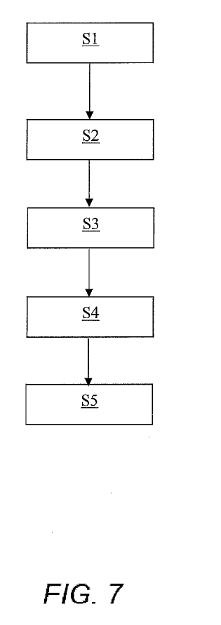

FIG. 7 is a flow chart illustrating five of the steps S1-S5 performed in the operation of the processor. The first step S1 performed by the processor is to retrieve the value of the inclination α1 of the lower planar member 7A measured by the first inclinometer. The second step S2 performed by the processor is to retrieve the value of the inclination α2 of the upper planar member 7B measured by the second inclinometer. The third step S3 performed by the processor is to retrieve the value of the length L of the lower and upper torque links 6A, 6B. In the present embodiment of the invention the length L of the lower and upper torque links 6A, 6B is pre-programmed into a memory unit (not shown). Thus, the third step S3 comprises retrieving the value of the length L of the lower and upper torque links 6A, 6B from the memory unit. However, it should be recognised that alternatively the third step S3 may comprise prompting the user to enter a value for the length L of the lower and upper torque links 6A, 6B using, for example, an input device such as a keyboard that is connected to the processor. The fourth step S4 performed by the processor comprises calculating the value of the shock absorber extension H using Equation 1. The fifth step S5 performed by the processor comprises outputting the calculated shock absorber extension H to the display.

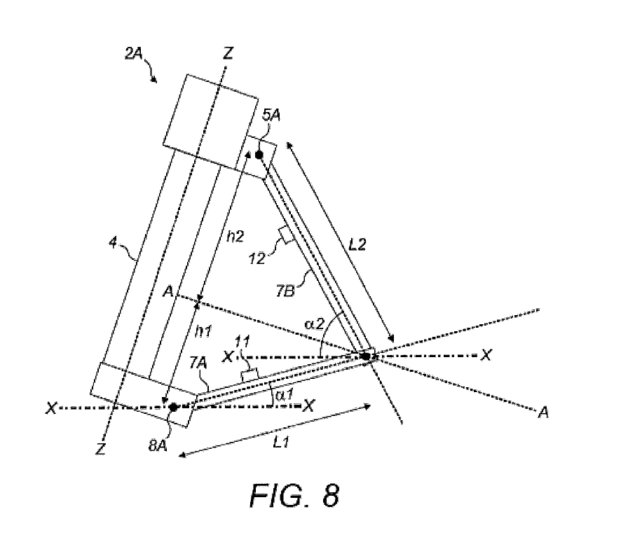

Referring now to FIG. 8, the device of the first embodiment of the invention is shown mounted to a second configuration of shock absorber 2A. The shock absorber 2A shown in FIG. 8 is similar to the shock absorber 2 shown in FIGS. 5 and 6, with similar features retaining the same reference numerals. A difference between the shock absorber 2A shown in FIG. 8 and the shock absorber 2 shown in FIGS. 5 and 6 is that the length L1 of the lower torque link 6A is not equal to the length L2 of the upper torque link 6B.

The shock absorber extension H can be calculated from the value of the lengths L1, L2, of the lower and upper torque links 6A, 6B and the value of the inclinations α1, α2 of the lower and upper planar members 7A, 7B using trigonometry.

The lengths L1, L2, of the lower and upper torque links 6A, 6B may be found by measurement using a rule. The lengths L1, L2 of the lower and upper torque links 6A, 6B are not affected by the quantities of the nitrogen gas and hydraulic oil in the shock absorber 2A and therefore only need to be measured once. Alternatively, the lengths L1, L2 may be found in the servicing manual for the aircraft.

Equation 2 shows the relationship between the shock absorber extension H, the lengths L1, L2 of the lower and upper torque links 6A, 6B, and the inclinations α1, α2 of the lower and upper planar members 7A, 7B.

H=\sqrt{L₁²+L₂²−2L₁L₂ cos(|α1|+|α2|)} [Equation 2]

The processor is programmed with the lengths L1, L2 of the lower and upper torque links 6A, 6B. The values of the inclinations α1, α2 of the lower and upper planar members 7A, 7B measured by the first and second inclinometers are input into the processor, which calculates the shock absorber extension H using Equation 2. The processor is coupled to the display such that the calculated shock absorber extension H is displayed to the user. The user can then use the calculated shock absorber extension H to calculate the volumes of nitrogen gas and hydraulic oil in the shock absorber 2, using methods known in the art.

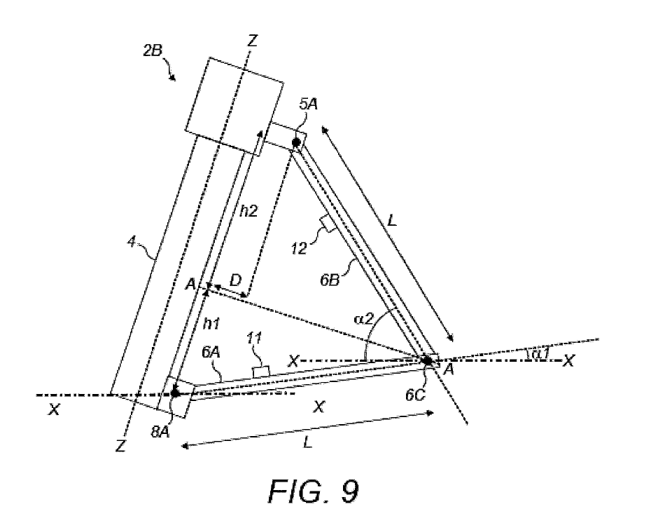

Referring now to FIG. 9, the device of the first embodiment of the invention is shown mounted to a third configuration of shock absorber 2B. The shock absorber 2B shown in FIG. 9 is similar to the shock absorber 2 shown in FIGS. 5 and 6, with similar features retaining the same reference numerals. As with the shock absorber 2 shown in FIGS. 5 and 6, the shock absorber 2B shown in FIG. 9 comprises lower and upper torque links 6A, 6B that are equal in length L. A difference between the shock absorber 2B shown in FIG. 9 and the shock absorber 2 shown in FIGS. 5 and 6 is that the distance between the first pivotal connection 5A and the central axis Z-Z of the slide 4 is greater than the distance between the second pivotal connection 8A and the central axis Z-Z of the slide 4 by an offset distance D. Therefore, the distance between the first and second pivotal connections 5A, 8A is not equal to the shock absorber extension H.

To calculate the shock absorber extension H, lower and upper shock absorber extensions h1, h2 are calculated. The lower shock absorber extension h1 is the distance between the second pivotal connection 8A and an imaginary altitude line A-A which extends from the hinge 6C and perpendicularly intersects the central axis Z-Z of the slide 4. The upper shock absorber extension h2 is the distance between the first pivotal connection 5A and the altitude line A-A. The shock absorber extension H is equal to the sum of the lower and upper shock absorber extensions h1, h2, as shown in Equation 3.

H=h₁+h₂ [Equation 3]

The values of the lower and upper shock absorber extensions h1, h2 can be calculated from the value of the length L of the lower and upper torque links 6A, 6B, the offset distance D of the first and second pivotal connections 5A, 8A, and the value of the inclinations α1, α2 of the lower and upper planar members 7A, 7B by solving Equations 4 and 5, shown below, simultaneously.

Equation 4 shows the relationship between the lower and upper shock absorber extensions h1, h2, the offset distance D, and the length L of the lower and upper torque links 6A, 6B.

h₁=\sqrt{h₂²−2D(L²−h₂²)^{0.5}−D²} [Equation 4]

Equation 5 shows the relationship between the lower and upper shock absorber extensions h1, h2, the length L of the lower and upper torque links 6A, 6B, and the inclinations α1, α2 of the lower and upper planar members 7A, 7B.

L² sin(|α1|+|α2|)=h₁(L²−h₂²)^{0.5}+h₂(L²−h₁²)^{0.5} [Equation 5]

The processor is programmed with the length L of the lower and upper torque links 6A, 6B. The values of the inclinations α1, α2 of the lower and upper planar members 7A, 7B measured by the first and second inclinometers are input into the processor, which calculates the lower and upper shock absorber extensions h1, h2 by simultaneously solving Equations 4 and 5. The shock absorber extension H is then calculated by addition of the lower and upper shock absorber extensions h1, h2. The processor is coupled to the display such that the calculated shock absorber extension H is displayed to the user.

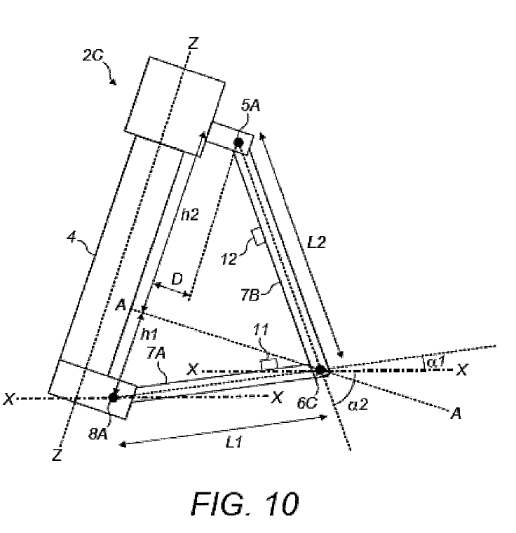

Referring now to FIG. 10, the device of the first embodiment of the invention is shown mounted to a fourth configuration of shock absorber 2C. The shock absorber 2C shown in FIG. 10 is similar to the shock absorber 2B shown in FIG. 9, with similar features retaining the same reference numerals. As with the shock absorber 2B shown in FIG. 9, the shock absorber 2C shown in FIG. 10 is configured such that the distance between the first pivotal connection 5A and the central axis Z-Z of the slide 4 is greater than the distance between the second pivotal connection 8A and the central axis Z-Z of the slide 4 by an offset distance D. A difference between the shock absorber 2C shown in FIG. 10 and the shock absorber 2B shown in FIG. 9 is that the shock absorber 2C shown in FIG. 10 comprises a lower torque link 6A having a length L1 that is not equal to the length L2 of the upper torque link 6B.

To calculate the shock absorber extension H, lower and upper shock absorber extensions h1, h2 are calculated. The lower shock absorber extension h1 is the distance between the second pivotal connection 8A and an imaginary altitude line A-A which extends from the hinge 6C and perpendicularly intersects the central axis Z-Z of the slide 4. The upper shock absorber extension h2 is the distance between the first pivotal connection 5A and the altitude line A-A. The shock absorber extension H is equal to the sum of the lower and upper shock absorber extensions h1, h2, as shown in Equation 3 above.

The values of the lower and upper shock absorber extensions h1, h2 can be calculated from the values of the lengths L1, L2 of the lower and upper torque links 6A, 6B, the offset distance D of the first and second pivotal connections 5A, 8A, and the value of the inclinations α1, α2 of the lower and upper planar members 7A, 7B by solving Equations 6 and 7, shown below, simultaneously.

Equation 6 shows the relationship between the lower and upper shock absorber extensions h1, h2, the offset distance D, and the lengths L1, L2 of the lower and upper torque links 6A, 6B.

h₁=\sqrt{h₂²+L₁²−L₁²−L₂²2D(L₂²−h₂²)^{0.5}−D²} [Equation 6]

Equation 7 shows the relationship between the lower and upper shock absorber extensions h1, h2, the lengths L1, L2 of the lower and upper torque links 6A, 6B, and the inclinations α1, α2 of the lower and upper planar members 7A, 7B.

L₁L₂ sin(|α1|+|α2|)=h₁(L₂²−h₂²)^{0.5}+h₂(L₁²−h₁²)^{0.5} [Equation 7]

The processor is programmed with the lengths L1, L2 of the lower and upper torque links 6A, 6B. The values of the inclinations α1, α2 of the lower and upper planar members 7A, 7B measured by the first and second inclinometers are input into the processor, which calculates the lower and upper shock absorber extensions h1, h2 by simultaneously solving Equations 6 and 7. The shock absorber extension H is then calculated by addition of the lower and upper shock absorber extensions h1, h2. The processor is coupled to the display such that the calculated shock absorber extension H is displayed to the user.

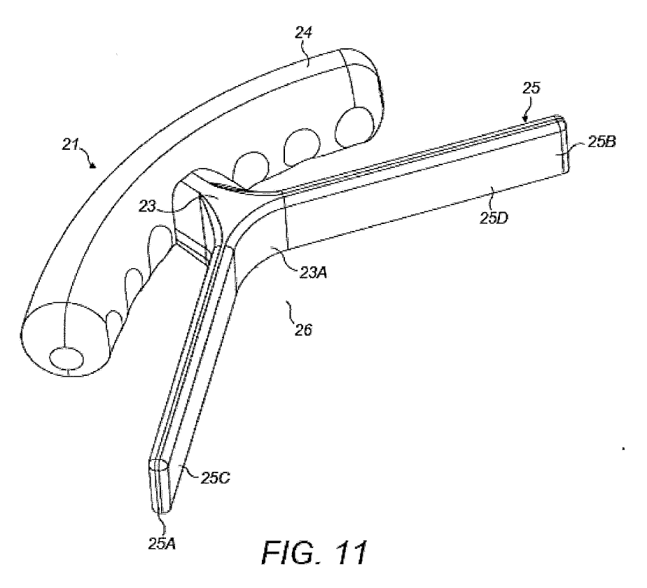

Referring now to FIGS. 11 to 20, a device for checking a landing gear shock absorber according to a second embodiment of the invention is shown.

The device of the second embodiment of the invention is similar to the device of the first embodiment of the invention and comprises a first torque mount 11 that is identical to the first torque link mount 11 of the first embodiment of the invention. A difference between the device of the first embodiment of the invention and the device of the second embodiment is that the second torque link mount 12 is omitted and is replaced by a slide mount 21.

The slide mount 21 comprises a body portion 23, a handle 24 and an attachment means 25. The handle 24 is located at a first end of the body portion 23. The attachment means 25 comprises first and second arms 25A, 25B that extend from a second end of the body portion 23, distal the handle 24.

The second end of the body portion 23 comprises a curved surface 23A. The first and second arms 25A, 25B extend from distal edges of the curved surface and each comprises a planar surface 25C, 25D. The surface 23A of the body portion 23 and the planar surfaces 25C, 25D of the first and second arms 25A, 25B together form a substantially “V” shaped surface that defines a recess 26. It should be recognised that the surface 23A of the body portion 23 may alternatively be another shape, for example, flat, such that the first and second arms 25A, 25B and the body portion 23 together form a substantially “V” shaped surface.

The body portion 23, handle 24 and first and second arms 25A, 25B of the slide mount 21 are integrally formed or are secured together, for example, by adhesive or screws. The first and second arms 25A, 25B each comprise a magnet (not shown).

The device comprises first and second inclinometers (not shown), a processor (not shown) and a display (not shown). Similarly to the device of the first embodiment of the invention, the first inclinometer of the device of the second embodiment of the invention is disposed on or inside the body portion 13 of the first torque link mount 11. The second inclinometer is disposed on or inside the body portion 23 of the slide mount 21. The second inclinometer may be releasably mounted to the slide mount 21 by, for example, non-permanent adhesive, screws, a bracket or a clamp, or integrally formed with the slide mount 21.

The first torque link mount 11 is configured to be removably mounted to the lower or upper torque link 6A, 6B of the torque link 6 so that the first inclinometer can measure the inclination α1, α2 of the lower or upper planar member 7A, 7B. The slide mount 21 is configured to be removably mounted to the slide 4 so that the second inclinometer can measure the inclination α3 of the slide 4.

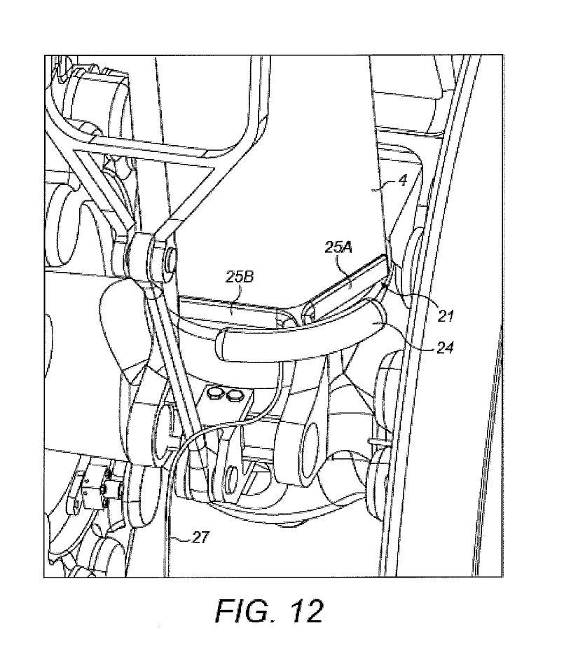

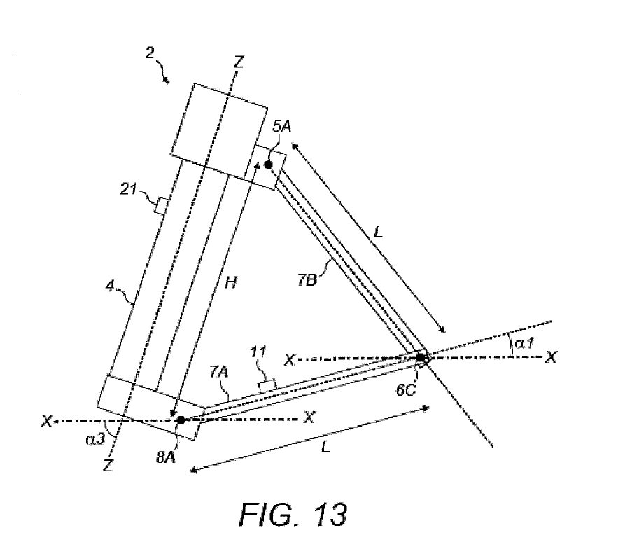

FIGS. 12 and 13 show the device mounted to a shock absorber that is identical in construction to the shock absorber 2 shown in FIGS. 5 and 6, with like components retaining the same reference numerals.

The first torque link mount 11 is mounted to the lower torque link 6A of the shock absorber 2, in the manner previously described, such that the attachment portion 15 extends into the hole 7C in the lower planar member 7A. The slide mount 21 is mounted to the slide 4 of the shock absorber 2.

To mount the slide mount 21 to the slide 4, the user grips the handle 24 and positions the slide mount 21 such that the “V” shaped surface of the attachment means 25 abuts the slide 4. When the slide mount 21 is mounted to the slide 4, a portion of the slide 4 is disposed in the recess 26 in the attachment means 25 and the first and second arms 25A, 25B extend in opposite directions about a portion of the circumference of the slide 4. The slide 4 comprises a ferrous material and therefore the magnets disposed in the first and second arms 25A, 25B are magnetically attracted to slide 4 such that the slide mount 21 is held in position on the slide 4. The attachment means 25 is suitable for use with slides 4 of various different diameters. This is because a portion of planar surface 25C, 25D of each arm 25A, 25B will abut the slide 4, regardless of the diameter of the slide 4.

The strength of the magnets disposed in the first and second arms 25A, 25B is chosen so that the magnets are powerful enough to hold the slide mount 21 in position on the slide 4 but weak enough that the slide mount 21 can easily be detached from the slide 4 when the user pulls on the handle 24. In alternate embodiments (not shown), the magnets are omitted and instead an alternative attachment means is provided to secure the slide mount to the slide. In one such embodiment (not shown), the slide mount is secured to the slide by a ratchet strap. The ratchet strap comprises a pair of straps that are secured to the first and second arms of the slide mount respectively. The ratchet straps are wrapped around the slide and then are fastened together using a ratchet connection mechanism. In yet another embodiment (not shown), first and second elastic straps are connected to the first and second arms respectively. The first and second elastic straps are secured together by a fastener, such as a clamp or VELCRO™, to secure the slide mount to the slide. The attachment means of each of the above described embodiments advantageously allows for the slide mount 21 to be mounted to slides 4 of various different diameters.

The second inclinometer is connected to the processor by a cable 27 such that the value of the inclination α3 of the slide is input into the processor. The inclination α3 of the slide 4 is the angle of the central axis Z-Z of the slide 4 with respect to the horizontal (shown by dashed line X-X). The first inclinometer is connected to the processor by a cable (not shown) such that the value of the inclination α2 of the upper planar member 7B is input into the processor.

The distance between the first pivotal connection 5A and the central axis Z-Z of the slide 4 is equal to the distance between the second pivotal connection 8A and the central axis Z-Z of the slide 4. Therefore, the distance between the first and second pivotal connections 5A, 8A is equal to the shock absorber extension H.

The length L of the lower torque link 6A is the distance between the second pivotal connection 8A and the hinge 6C. The length L of the upper torque link 6B is the distance between the first pivotal connection 5A and the hinge 6C. The lengths L of the lower and upper torque links 6A, 6B are equal. The shock absorber extension H can be calculated from the value of the length L and the value of the inclinations α1, α3 of the lower planar member 7A and slide 4 using trigonometry.

Equation 8 shows the relationship between the shock absorber extension H, the length L of the lower and upper torque links 6A, 6B, and the inclinations α1, α3 of the lower planar member 7A and the slide 4.

H=2L cos(|α3|−|α1|) [Equation 8]

The processor is programmed with the length L of the lower or upper torque links 6A, 6B. The values of the inclinations α1, α3 of the lower planar member 7A and the slide 4 measured by the first and second inclinometers are input into the processor, which calculates the shock absorber extension H using Equation 8. The processor is coupled to the display such that the calculated shock absorber extension H is displayed to the user. The user can then use the calculated shock absorber extension H to calculate the volumes of nitrogen gas and hydraulic oil in the shock absorber 2, using methods known in the art.

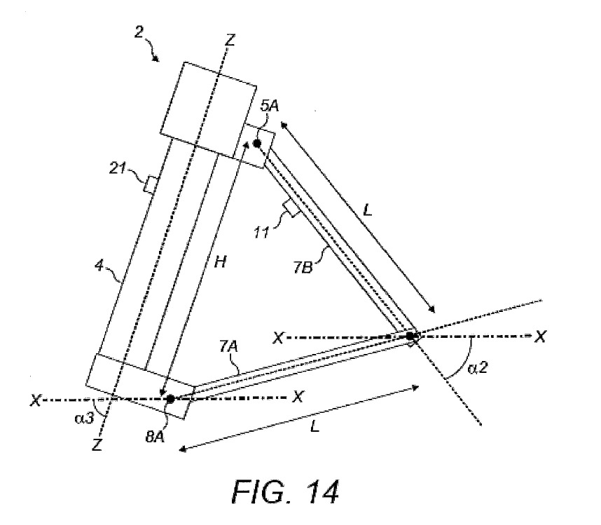

FIG. 14 shows the device of the second embodiment of the invention mounted to the same shock absorber 2 that is shown in FIGS. 12 and 13. However, in FIG. 14 the device is configured such that the first inclinometer measures the inclination α2 of the upper planar member 7B instead of measuring the inclination α1 of the lower planar member 7A. This is achieved by mounting the first torque link mount 11 to the upper torque link 6B such that the attachment portion 15 extends into the hole 7D in the upper planar member 7B. The slide mount 21 is mounted to the slide 4 such that the second inclinometer measures the inclination α3 of the slide 4.

Equation 9 shows the relationship between the shock absorber extension H, the length L of the lower and upper torque links 6A, 6B, and the inclinations α2, α3 of the upper planar member 7B and the slide 4.

H=2L sin(|α2|+|α3|−90) [Equation 9]

The processor is programmed with the length L of the lower and upper torque links 6A, 6B. The value of the inclinations α2, α3 of the upper planar member 7B and the slide 4 measured by the first and second inclinometers is input into the processor, which calculates the shock absorber extension H using Equation 9. The processor is coupled to the display such that the calculated shock absorber extension H is displayed to the user.

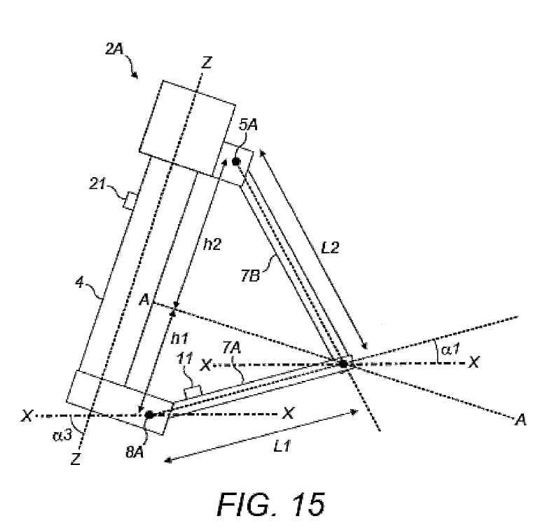

Referring now to FIG. 15, the device of the second embodiment of the invention is shown mounted to the second configuration of shock absorber 2A shown in FIG. 7. The length L1 of the lower torque link 6A is not equal to the length L2 of the upper torque link 6B. The device is configured such that the first torque link mount 11 is mounted to the lower torque link 6A and the slide mount 21 is mounted to the slide 4. Therefore, the first inclinometer measures the inclination α1 of the lower planar member 7A and the second inclinometer measures the inclination α3 of the slide 4.

To calculate the shock absorber extension H, lower and upper shock absorber extensions h1, h2 are calculated. The lower shock absorber extension h1 is the distance between the second pivotal connection 8A and an imaginary altitude line A-A which extends from the hinge 6C and perpendicularly intersects the central axis Z-Z of the slide 4. The upper shock absorber extension h2 is the distance between the first pivotal connection 5A and the altitude line A-A. The shock absorber extension H is equal to the sum of the lower and upper shock absorber extensions h1, h2, as shown in Equation 3 above.

The values of the lower and upper shock absorber extensions h1, h2 can be calculated from the values of the lengths L1, L2 of the lower and upper torque links 6A, 6B, the offset distance D of the first and second pivotal connections 5A, 8A, and the value of the inclinations α1, α3 of the lower planar member 7A and the slide 4 by solving Equations 10 and 11, shown below.

Equation 10 shows the relationship between the lower shock absorber extension h1, the length L1 of the lower torque link 6A and the value of the inclinations α1, α3 of the lower planar member 7A and slide 4.

h₁=L₁ cos(|α3|−|α1|) [Equation 10]

Equation 11 shows the relationship between the upper shock absorber extension h2, the lengths L1, L2 of the lower and upper torque links 6A, 6B, and the value of the inclinations α1, α3 of the lower planar member 7A and slide 4.

h₂={square root over (L₂²−L₁²+(L₁ cos(|α3|−|α1|))²)} [Equation 11]

The processor is programmed with the lengths L1, L2 of the lower and upper torque links 6A, 6B. The values of the inclinations α1, α3 of the lower planar member 7A and the slide 4 measured by the first and second inclinometers are input into the processor, which calculates the lower and upper shock absorber extensions h1, h2 by solving Equations 10 and 11. The shock absorber extension H is then calculated by addition of the lower and upper shock absorber extensions h1, h2. The processor is coupled to the display such that the calculated shock absorber extension H is displayed to the user.

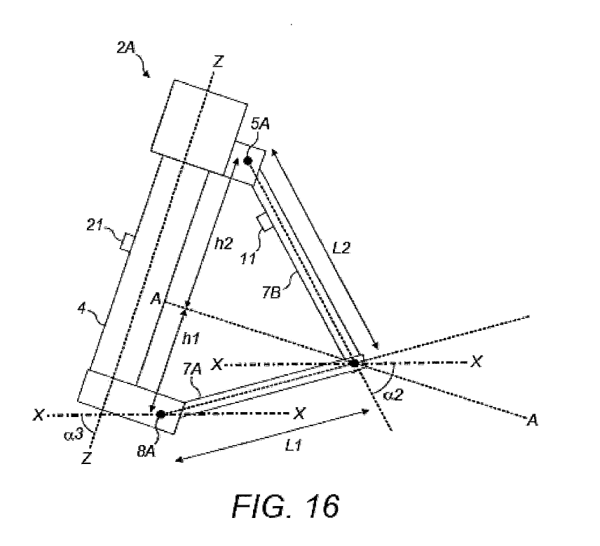

FIG. 16 shows the device of the second embodiment of the invention mounted to the same shock absorber 2A that is shown in FIG. 15. However, in FIG. 16 the device is configured such that the first inclinometer measures the inclination α2 of the upper planar member 7B instead of measuring the inclination α1 of the lower planar member 7A. This is achieved by mounting the first torque link mount 11 to the upper torque link 6B such that the attachment portion 15 extends into the hole 7D in the upper planar member 7B. The slide mount 21 is mounted to the slide 4 such that the second inclinometer measures the inclination α3 of the slide 4.

The values of the lower and upper shock absorber extensions h1, h2 can be calculated from the values of the lengths L1, L2 of the lower and upper torque links 6A, 6B, the offset distance D of the first and second pivotal connections 5A, 8A, and the value of the inclinations α2, α3 of the upper planar member 7B and slide 4 by solving Equations 12 and 13, shown below.

Equation 12 shows the relationship between the upper shock absorber extension h2, the length L2 of the upper torque link 6B and the value of the inclinations α2, α3 of the upper planar member 7B and slide 4.

h₂=L₂ sin(|α2|+|α3|−90) [Equation 12]

Equation 13 shows the relationship between the lower shock absorber extension h1, the lengths L1, L2 of the lower and upper torque links 6A, 6B, and the value of the inclinations α2, α3 of the upper planar member 7B and slide 4.

h₁={square root over (L₁²−L₂²+(L₂ sin(|α2|+|α3|−90))²)} [Equation 13]

The processor is programmed with the lengths L1, L2 of the lower and upper torque links 6A, 6B. The values of the inclinations α2, α3 of the upper planar member 7B and the slide 4 measured by the first and second inclinometers are input into the processor, which calculates the lower and upper shock absorber extensions h1, h2 by solving Equations 12 and 13. The shock absorber extension H is then calculated by addition of the lower and upper shock absorber extensions h1, h2. The processor is coupled to the display such that the calculated shock absorber extension H is displayed to the user.

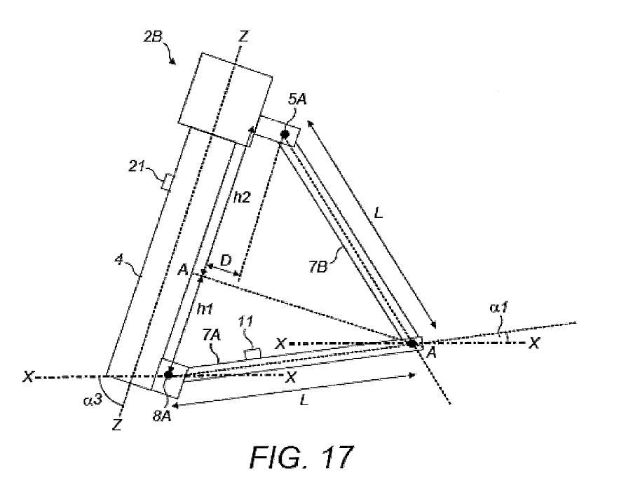

Referring now to FIG. 17, the device of the second embodiment of the invention is shown mounted to the third configuration of shock absorber 2B shown in FIG. 9. The shock absorber 2B is configured such that the distance between the first pivotal connection 5A and the central axis Z-Z of the slide 4 is greater than the distance between the second pivotal connection 8A and the central axis Z-Z of the slide 4 by an offset distance D. Therefore, the distance between the first and second pivotal connections 5A, 8A is not equal to the shock absorber extension H. The device is configured such that the first torque link mount 11 is mounted to the lower torque link 6A and the slide mount 21 is mounted to the slide 4. Therefore, the first inclinometer measures the inclination α1 of the lower planar member 7A and the second inclinometer measures the inclination α3 of the slide 4.

To calculate the shock absorber extension H, lower and upper shock absorber extensions h1, h2 are calculated. The lower shock absorber extension h1 is the distance between the second pivotal connection 8A and an imaginary altitude line A-A which extends from the hinge 6C and perpendicularly intersects the central axis Z-Z of the slide 4. The upper shock absorber extension h2 is the distance between the first pivotal connection 5A and the altitude line A-A. The shock absorber extension H is equal to the sum of the lower and upper shock absorber extensions h1, h2, as shown in Equation 3 above.

The values of the lower and upper shock absorber extensions h1, h2 can be calculated from the value of the length L of the lower and upper torque links 6A, 6B, the offset distance D of the first and second pivotal connections 5A, 8A, and the value of the inclinations α1, α3 of the lower planar member 7A and slide 4 by solving Equation 4, shown above, and Equation 14, shown below.

Equation 14 shows the relationship between the lower shock absorber extension h1, the length L of the lower and upper torque links 6A, 6B, and the value of the inclinations α1, α3 of the lower planar member 7A and the slide 4.

h¹=L cos(|α3|−|α1|) [Equation 14]

The processor is programmed with the length L of the lower and upper torque links 6A, 6B. The values of the inclinations α1, α3 of the lower planar member 7A and the slide 4 measured by the first and second inclinometers are input into the processor, which calculates the lower and upper shock absorber extensions h1, h2 by solving Equations 4 and 14. The shock absorber extension H is then calculated by addition of the lower and upper shock absorber extensions h1, h2. The processor is coupled to the display such that the calculated shock absorber extension H is displayed to the user.

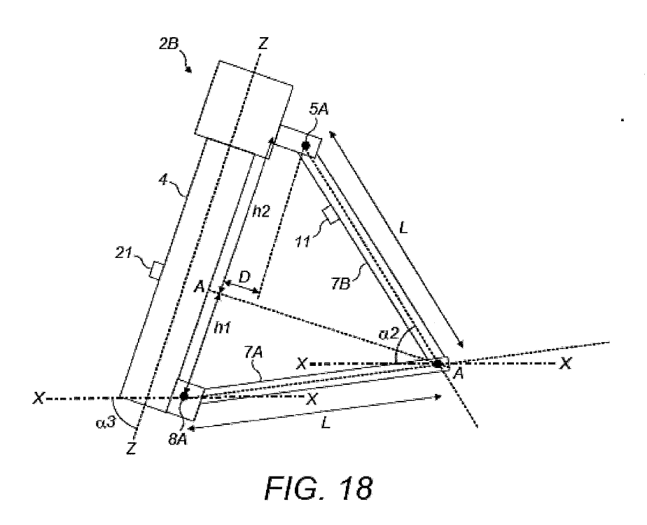

FIG. 18 shows the device of the second embodiment of the invention mounted to the same shock absorber 2B that is shown in FIG. 17. However, in FIG. 18 the device is configured such that the first inclinometer measures the inclination α2 of the upper planar member 7B instead of measuring the inclination α1 of the lower planar member 7A.

The values of the lower and upper shock absorber extensions h1, h2 can be calculated from the value of the length L of the lower and upper torque links 6A, 6B, the offset distance D of the first and second pivotal connections 5A, 8A, and the value of the inclinations α2, α3 of the upper planar member 7B and slide 4 by solving Equation 4, shown above, and Equation 15, shown below.

Equation 15 shows the relationship between the upper shock absorber extension h2, the lengths L1, L2 of the lower and upper torque links 6A, 6B, and the value of the inclinations α2, α3 of the upper planar member 7B and slide 4.

h₂=L sin(|α2|+|α3|−90) [Equation 15]

The processor is programmed with the length L of the lower and upper torque links 6A, 6B. The values of the inclinations α2, α3 of the upper planar member 7B and the slide 4 measured by the first and second inclinometers are input into the processor, which calculates the lower and upper shock absorber extensions h1, h2 by solving Equations 4 and 15. The shock absorber extension H is then calculated by addition of the lower and upper shock absorber extensions h1, h2. The processor is coupled to the display such that the calculated shock absorber extension H is displayed to the user.

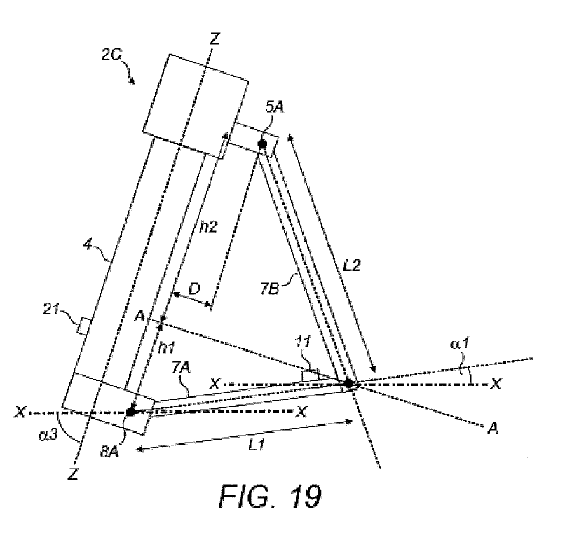

Referring now to FIG. 19, the device of the second embodiment of the invention is shown mounted to the fourth configuration of shock absorber 2C shown in FIG. 10. The shock absorber 2C is configured such that the distance between the first pivotal connection 5A and the central axis Z-Z of the slide 4 is greater than the distance between the second pivotal connection 8A and the central axis Z-Z of the slide 4 by an offset distance D. Therefore, the distance between the first and second pivotal connections 5A, 8A is not equal to the shock absorber extension H. In addition, the length L1 of the lower torque link 6A is not equal to the length L2 of the upper torque link 6B. The device is configured such that the first torque link mount 11 is mounted to the lower torque link 6A and the slide mount 21 is mounted to the slide 4. Therefore, the first inclinometer measures the inclination α1 of the lower planar member 7A and the second inclinometer measures the inclination α3 of the slide 4.

To calculate the shock absorber extension H, lower and upper shock absorber extensions h1, h2 are calculated. The lower shock absorber extension h1 is the distance between the second pivotal connection 8A and an imaginary altitude line A-A which extends from the hinge 6C and perpendicularly intersects the central axis Z-Z of the slide 4. The upper shock absorber extension h2 is the distance between the first pivotal connection 5A and the altitude line A-A. The shock absorber extension H is equal to the sum of the lower and upper shock absorber extensions h1, h2, as shown in Equation 3 above.

The values of the lower and upper shock absorber extensions h1, h2 can be calculated from the values of the lengths L1, L2 of the lower and upper torque links 6A, 6B, the offset distance D of the first and second pivotal connections 5A, 8A, and the value of the inclinations α1, α2 of the lower and upper planar members 7A, 7B by solving Equations 6 and 10, shown above, simultaneously.

The processor is programmed with the lengths L1, L2 of the lower and upper torque links 6A, 6B. The values of the inclinations α1, α3 of the lower planar member 7A and the slide 4 measured by the first and second inclinometers are input into the processor, which calculates the lower and upper shock absorber extensions h1, h2 by solving Equations 6 and 10 simultaneously. The shock absorber extension H is then calculated by addition of the lower and upper shock absorber extensions h1, h2. The processor is coupled to the display such that the calculated shock absorber extension H is displayed to the user.

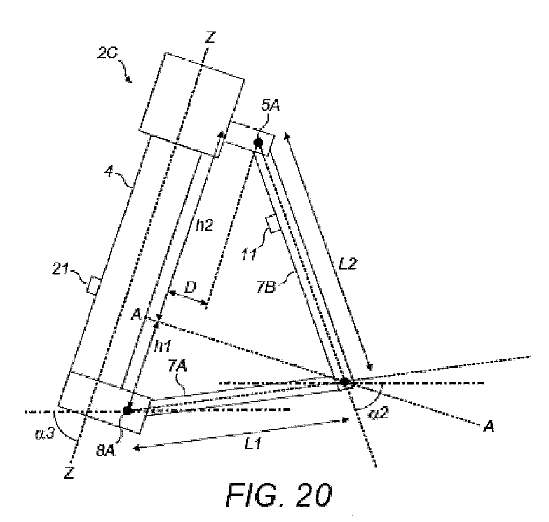

FIG. 20 shows the device of the second embodiment of the invention mounted to the same shock absorber 2C that is shown in FIG. 19. However, in FIG. 20 the device is configured such that the first inclinometer measures the inclination α2 of the upper planar member 7B instead of measuring the inclination α1 of the lower planar member 7A.

The values of the lower and upper shock absorber extensions h1, h2 can be calculated from the value of the lengths L1, L2 of the lower and upper torque links 6A, 6B, the offset distance D of the first and second pivotal connections 5A, 8A, and the value of the inclinations α2, α3 of the upper planar member 7B and slide 4 by solving Equations 6 and 12, shown above, simultaneously.

The processor is programmed with the lengths L1, L2 of the lower and upper torque links 6A, 6B. The values of the inclinations α2, α3 of the upper planar member 7B and the slide 4 measured by the first and second inclinometers are input into the processor, which calculates the lower and upper shock absorber extensions h1, h2 by solving Equations 6 and 12 simultaneously. The shock absorber extension H is then calculated by addition of the lower and upper shock absorber extensions h1, h2. The processor is coupled to the display such that the calculated shock absorber extension H is displayed to the user.

In the above described embodiments, the first and second torque link mounts 11, 12 and the slide mount 21 allow for the first and second inclinometers to be easily temporarily mounted to the shock absorber 2, 2A, 2B, 2C. Temporary attachment of the first and second inclinometers is advantageous since the first and second inclinometers can be removed from the shock absorber 2, 2A, 2B, 2C when the shock absorber extension H is not being measured to reduce the weight of the landing gear. In addition, the first and second inclinometers can be temporarily mounted to the shock absorber 2, 2A, 2B, 2C of conventional aircraft landing gear without requiring any modification of the shock absorber 2, 2A, 2B, 2C, thereby reducing the cost and complexity of measuring the shock absorber extension H and negating the requirement for mounting brackets to be installed on the shock absorber 2, 2A, 2B, 2C which would increase the weight thereof. However, in alternative embodiments (not shown) the first and second torque link mounts 11, 12 and the slide mount 21 are omitted and instead the first and second inclinometers are secured directly to two of the slide 4, lower torque link 6A and upper torque link 6B. For example, the first and second inclinometers may be secured to the shock absorber 2, 2A, 2B, 2C using adhesive or screws. Alternatively, the housings of the first and second inclinometers may be integrally formed with the shock absorber 2, 2A, 2B, 2C.

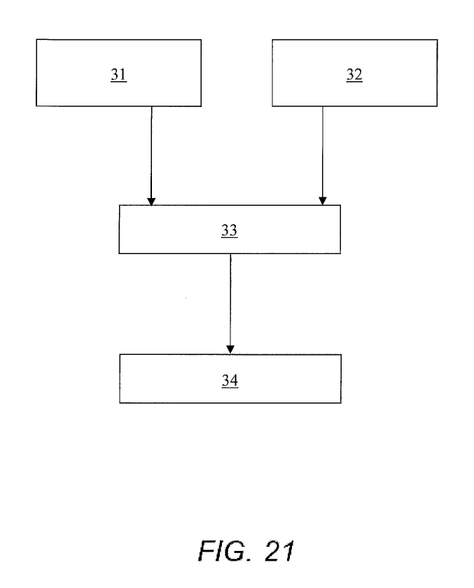

Referring now to FIG. 21, a block diagram of the device according to the first and second embodiments of the invention is shown. The block diagram shows the configuration of the first and second inclinometers 31, 32, the processor 33 and the display 34. The first and second inclinometers 31, 32 are configured such that the values of the inclinations α1, α2, α3 measured thereby are input into the processor 33. The processor 33 is configured to calculate the value of the shock absorber extension H based on the values of the inclinations α1, α2, α3 measured by the first and second inclinometers and the length L, L1, L2 of the lower and upper torque links 6A, 6B. The value of the shock absorber extension H is output to the display 34.

Although in the above described embodiments the processor is configured to calculate the shock absorber extension H by solving the relevant above equations, it should be recognised that the processor may be configured to solve the shock absorber extension H using alternative means, for example, using numerical analysis, look-up tables, or iterative methods.

In the above described embodiments, the processor may comprise part of the onboard aircraft system. Alternatively, the processor may comprise a separate unit that is only connected to the first and second inclinometers when the shock absorber extension H is to be calculated. In such an embodiment, the processor may comprise, for example, a microcontroller or laptop.

Although in the above described embodiments the values of the inclinations measured by the first and second inclinometers are input into the processor, in an alternate embodiments (not shown) the processor is omitted. In one such embodiment, the first and second inclinometers are connected to the display such that the inclinations α1, α2, α3 measured by the first and second inclinometers are displayed by the display. The user may then calculate the shock absorber extension H by solving the relevant above equations by hand. Alternatively, the user may be provided with a look-up table that tabulates the shock absorber extension H for all combinations of inclinations α1, α2, α3 of the lower and upper planar members 7A, 7B and slide 4. In such an embodiment, the user refers to the look-up table to find the shock absorber extension H that corresponds to the inclinations α1, α2, α3 measured by the first and second inclinometers.

In the above described embodiments, the first and second inclinometers may each comprise one-axis inclinometers. In such embodiments, the rotational position of the body portions 13, 23 of the first and second torque link mounts 11, 12 and/or the slide mount 21 about their respective central axis will affect the value of the inclinations α1, α2, α3 measured by the first and second inclinometers. For example, if the slide mount 21 is twisted on the slide 4 such that the first arm 24A is higher than the second arm 24B, then the inclination measuring axis of the second inclinometer will not extend vertically and so the second inclinometer may give an inaccurate measurement of the inclination α3 of the slide 4. Therefore, to improve the accuracy of the value of the α1, α2, α3 measured by the first and second inclinometers, the first and second torque link mounts 11, 12 and/or the slide mount 21 may each be provided with a visual indicator, for example a spirit level or a marking that is aligned with a component of the shock absorber, to ensure consistent positioning of the measuring axis thereof. Alternatively, the first and second inclinometers may each comprise two-axis or three-axis inclinometers, in which case the first and second inclinometers can measure the rotational position of the body portions 13, 23 of the first and second torque link mounts 11, 12 and the slide mount 21 and compensate for any rotation thereof.

It will be appreciated that the foregoing description is given by way of example only and that modifications may be made to the present invention without departing from the scope of the appended claims.

1. A device for checking a landing gear shock absorber comprising a first inclinometer configured to measure the inclination of one of a slide, lower torque link and upper torque link of said shock absorber and a second inclinometer configured to measure the inclination of another one of said slide, lower torque link and upper torque link.

2. A device according to claim 1, comprising a processor that is configured to calculate the shock absorber extension based on the inclinations measured by the first and second inclinometers.

3. A device according to claim 1, comprising a first mount configured to mount the first inclinometer to said one of the slide, lower torque link and upper torque link.

4. A device according to claim 3, wherein the first mount is configured to be mounted to one of the lower and upper torque links and comprises an attachment means that is configured to be received in said one of the lower and upper torque links.

5. A device according to claim 4, wherein said one of the lower and upper torque links comprises a hole and wherein the attachment means is configured to be inserted into said hole such that the attachment means is urged against the periphery of said hole to retain the first mount in position on said one of the lower and upper torque links.

6. A device according to claim 4, wherein the attachment means comprises a resilient material that is compressed when the attachment means is received in said one of the lower and upper torque links.

7. A device according to claim 4, wherein the first mount comprises a body portion and the attachment means comprises a first disc-shaped member located proximate the body portion.

8. A device according to claim 7, wherein the attachment means comprises a second disc-shaped member that is located on the opposite side of the first disc-shaped member to the body portion and has a diameter smaller than the diameter of the first disc-shaped member.

9. A device according to claim 4, wherein the first mount comprises a substantially flat abutment surface that sits flush to a planar surface of said one of the lower and upper torque links when the first mount is mounted thereto.

10. A device according to claim 1, comprising a second mount configured to mount the second inclinometer to said other one of the slide, lower torque link and upper torque link.

11. A device according to claim 10, wherein the second mount is configured to be mounted to said slide and comprises an attachment means configured to be received against said slide.

12. A device according to claim 11, wherein the attachment means comprises first and second arms.

13. A device according to claim 12, wherein the first and second arms are configured such that the attachment means comprises a substantially “V” shaped surface.

14. A device according to claim 11, wherein the attachment means comprises at least one magnet.

15. A device according to claim 11, wherein the attachment means comprises a ratchet strap.

16. A device according to claim 1, wherein the inclination of the slide, lower torque link and upper torque link is the angle between the horizontal and the slide, lower torque link and upper torque link respectively.

17. A method of checking a landing gear shock absorber, wherein the shock absorber comprises a slide and upper and lower torque links, and wherein the method comprises the steps of:
using a first inclinometer to measure the inclination of one of said slide, lower torque link and upper torque link;
using a second inclinometer to measure the inclination of another one of said slide, upper torque link and lower torque link; and,
calculating the shock absorber extension based on the inclinations measured by the first and second inclinometers.

18. A method according to claim 17, wherein the step of calculating the shock absorber extension is performed using a processor.

19. A method according to claim 17, wherein the step of using the first inclinometer to measure the inclination of said one of the slide, lower torque link and upper torque link comprises mounting the first inclinometer thereto using a first mount.

20. A method according to claim 19, wherein the first mount is configured to mount the first inclinometer to said one of the slide, lower torque link and upper torque link.

21. A method according to claim 17, wherein the step of using the second inclinometer to measure the inclination of said other one of the slide, lower torque link and upper torque link comprises mounting the second inclinometer thereto using a second mount.

22. A method according to claim 21, wherein the second mount is configured to mount the second inclinometer to said other one of the slide, lower torque link and upper torque link.

23. A device according to claim 1, wherein the first and second inclinometers comprise digital inclinometers and/or MEMS inclinometers.

24. A mount for mounting an inclinometer to one of a slide, lower torque link and upper torque link of an aircraft shock absorber.

25. A mount according to claim 24, wherein the mount is configured to mount the first inclinometer to said one of the slide, lower torque link and upper torque link.

26. A mount according to claim 24, wherein the mount is configured to mount the second inclinometer to said other one of the slide, lower torque link and upper torque link.

27. A landing gear shock absorber and a device according to claim 1, wherein the device is configured to check the landing gear shock absorber.

28. (canceled)

29. (canceled)

30. A method according to claim 17, wherein the first and second inclinometers comprise digital inclinometers and/or MEMS inclinometers.
